(19) United States
(12) Patent Application Publication
(10) Pub. No.: US 2026/0338687 A1
(43) Pub. Date: Oct. 29, 2026

(54) DEVICES, METHODS, AND SYSTEMS FOR MEASURING AND RECORDING A REACTANT ARRAY

(71) Applicant: SENSILL, INC., Concord, CA (US)

(72) Inventors: William Shea, Martinez, CA (US); Yan Zhou, Pleasanton, CA (US)

(73) Assignee: SENSILL, INC., Concord, CA (US)

(21) Appl. No.: 19/701,264

(22) Filed: Jun. 8, 2026

Related U.S. Application Data
(63) Continuation of application No. PCT/US2024/058809, filed on Dec. 6, 2024.
(60) Provisional application No. 63/607,926, filed on Dec. 8, 2023.
(60) Provisional application No. 63/607,936, filed on Dec. 8, 2023.
(60) Provisional application No. 63/621,024, filed on Jan. 15, 2024.
(60) Provisional application No. 63/656,306, filed on Jun. 5, 2024.
(60) Provisional application No. 63/656,311, filed on Jun. 5, 2024.
(60) Provisional application No. 63/656,320, filed on Jun. 5, 2024.

(51) Int. Cl. G01N 21/47

(52) U.S. Cl. CPC G01N 21/47; G01N 2021/4711; G01N 2201/0221

(57) ABSTRACT

Devices, systems, and methods may be configured to image a reactant array using an imaging system that includes a wide-angle field of view. The system may include a substrate including the reactant array and a reader device having a wide-angle imaging system with the wide-angle field of view. The wide-angle imaging system may be configured to capture an image of the reactant array along an optical path through the wide-angle field of view. The reactant array may be on a planar or non-planar surface of the substrate. The wide-angle imaging system may include, a wide-angle lens, a flat imaging sensor, and one or more illumination sources. The reader device may include a housing configured to house at least part of the imaging system.

### CROSS REFERENCE TO RELATED APPLICATIONS

This application is a continuation of International Application No. PCT/US2024/058809, filed Dec. 6, 2024, which claims priority to U.S. Provisional Patent Application No. 63/607,926, filed Dec. 8, 2023; U.S. Provisional Patent Application No. 63/607,936, filed Dec. 8, 2023; U.S. Provisional Patent Application No. 63/621,024, filed Jan. 15, 2024; U.S. Provisional Patent Application No. 63/656,306, filed Jun. 5, 2024; U.S. Provisional Patent Application No. 63/656,311, filed Jun. 5, 2024; and U.S. Provisional Patent Application No. 63/656,320, filed Jun. 5, 2024. The disclosures of the foregoing applications are incorporated herein by reference in their entireties.

### TECHNICAL FIELD

The present disclosure pertains to sensing and analysis tools, and the like. More particularly, the present disclosure pertains to devices and systems for sensing and analyzing objects, and methods for manufacturing and using such devices.

### BACKGROUND

A wide variety of devices have been developed for imaging and analyzing objects. These devices are manufactured by any one of a variety of different manufacturing methods and may be used according to any one of a variety of methods. Of the known medical devices and methods, each has certain advantages and disadvantages.

### BRIEF SUMMARY

This disclosure provides design, material, manufacturing method, and use alternatives for sensing and analysis devices. Although it is noted that sensing and analysis approaches and systems are known, there exists a need for improvement on those approaches and systems.

An example system may include a wide-angle lens, an imaging sensor, a non-planar surface, and one or more reactants on the non-planar surface, wherein the image sensor is configured to receive light from the one or more reactants on the non-planar surface through the wide-angle lens.

Alternatively or additionally to any of the embodiments in this section, the non-planar surface may be a concave surface.

Alternatively or additionally to any of the embodiments in this section, the system may further include an annular array of individually selectable light emitting diodes positioned around the image sensor.

Alternatively or additionally to any of the embodiments in this section, the image sensor may be a monochrome image sensor.

Alternatively or additionally to any of the embodiments in this section, the image sensor may be a color image sensor.

In another example, a method may include imaging a reactant array on a non-planar surface of a colorimetric sensor array (CSA), positioning the CSA over an area of interest after imaging the CSA, removing the CSA from the area of interest, and after removing the CSA from the area of interest, imaging the reactant array on the non-planar surface.

Alternatively or additionally to any of the embodiments in this section, the method may further include analyzing an image obtained from imaging the CSA after removing the CSA from the area of interest relative to an image obtained from imaging the CSA prior to positioning the CSA over the area of interest.

In another example, a system may include a wide-angle lens, an imaging sensor, a planar surface, and one or more reactants on the planar surface, wherein the image sensor may be configured to receive light from the one or more reactants of the planar surface through the wide-angle lens.

Alternatively or additionally to any of the embodiments in this section, the one or more reactants may be spaced to reduce color cross talk.

Alternatively or additionally to any of the embodiments in this section, the system may further include an annular array of individually selectable light emitting diodes positioned around the image sensor.

Alternatively or additionally to any of the embodiments in this section, the image sensor may be a monochrome image sensor.

Alternatively or additionally to any of the embodiments in this section, the image sensor may be a color image sensor.

Alternatively or additionally to any of the embodiments in this section, the one or more reactants may form a matrix of n-rows by n-columns, where n is at least one.

In another example, a system may include a substrate comprising a reactant array and a wide-angle imaging system having a wide-angle field of view, wherein the wide-angle imaging system is configured to capture an image of the reactant array along an optical path through the wide-angle field of view.

Alternatively or additionally to any of the embodiments in this section, the wide-angle imaging system may comprise a flat imaging sensor.

Alternatively or additionally to any of the embodiments in this section, the wide-angle imaging system may comprise a monochrome imaging sensor.

Alternatively or additionally to any of the embodiments in this section, the wide-angle imaging system may comprise a color imaging sensor.

Alternatively or additionally to any of the embodiments in this section, the system may further include an illumination source configured to illuminate the reactant array.

Alternatively or additionally to any of the embodiments in this section, the illumination source may comprise an annular array of individually selectable light sources positioned around an imaging sensor of the wide-angle imaging system.

Alternatively or additionally to any of the embodiments in this section, the system may further include a polarizer arranged between the illumination source and the reactant array along a path for light extending from the illumination source to the reactant array.

Alternatively or additionally to any of the embodiments in this section, the substrate may have a non-planar surface and the reactant array is on the non-planar surface.

Alternatively or additionally to any of the embodiments in this section, the non-planar surface may be a concave surface.

Alternatively or additionally to any of the embodiments in this section, the substrate may have a planar surface and the reactant array is on the planar surface.

Alternatively or additionally to any of the embodiments in this section, the wide-angle imaging system may comprise a controller configured to process the image captured by the wide-angle imaging system.

In another example, a device may include a wide-angle lens, a flat imaging sensor, an illumination source, and a housing configured to house the wide-angle lens, the flat imaging sensor, and the illumination source, wherein the illumination source is configured to illuminate an object and the flat imaging sensor is configured to capture light from the object through the wide-angle lens.

Alternatively or additionally to any of the embodiments in this section, the illumination source may comprise an annular array of a plurality of individually selectable light sources positioned around the flat imaging sensor.

Alternatively or additionally to any of the embodiments in this section, the flat imaging sensor may be configured to capture the light from the object to form a hyperspectral image of the object.

Alternatively or additionally to any of the embodiments in this section, the flat imaging sensor may be a monochrome imaging sensor.

Alternatively or additionally to any of the embodiments in this section, the flat imaging sensor may be a color imaging sensor.

Alternatively or additionally to any of the embodiments in this section, the device may further include a controller positioned within the housing, the controller is configured to process an image from the light captured by the flat imaging sensor.

In another example, a method may include positioning a reactant array in a wide-angle field of view of a wide-angle imaging system and imaging the reactant array by collecting light from the reactant array with the wide-angle imaging system.

Alternatively or additionally to any of the embodiments in this section, the method may include illuminating the reactant array with light from the wide-angle imaging system.

Alternatively or additionally to any of the embodiments in this section, the method may include exposing the reactant array to one or more fluids, wherein the reactant array is configured to react to one or more analytes of interest when the one or more analytes of interest are present in the one or more fluids.

Alternatively or additionally to any of the embodiments in this section, the method may include analyzing the reactant array by comparing two or more of the following: an image obtained from imaging the reactant array before exposing the reactant array to the one or more fluids, an image obtained from imaging the reactant array while exposing the reactant array to the one or more fluids, and an image obtained from imaging the reactant array after exposing the reactant array to the one or more fluids.

Alternatively or additionally to any of the embodiments in this section, the method may include analyzing an image obtained from imaging the reactant array.

Alternatively or additionally to any of the embodiments in this section, the reactant array may be on a non-planar surface of a substrate.

Alternatively or additionally to any of the embodiments in this section, imaging the reactant array may comprise collecting light from the reactant array with a flat imaging sensor of the wide-angle imaging system.

Alternatively or additionally to any of the embodiments in this section, imaging the reactant array may comprise collecting light from the reactant array with a monochrome imaging sensor of the wide-angle imaging system.

Alternatively or additionally to any of the embodiments in this section, imaging the reactant array may comprise collecting light from the reactant array with an imaging sensor of the wide-angle imaging system to create a hyperspectral image of the reactant array.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings.

FIG. 1 is a schematic diagram of an illustrative analysis system;

FIG. 2 is a schematic diagram of an illustrative computing system;

FIG. 3 is a schematic diagram of an illustrative analysis system in a hand of a user;

FIG. 4 is a schematic image taken with an illustrative wide-angle imaging system;

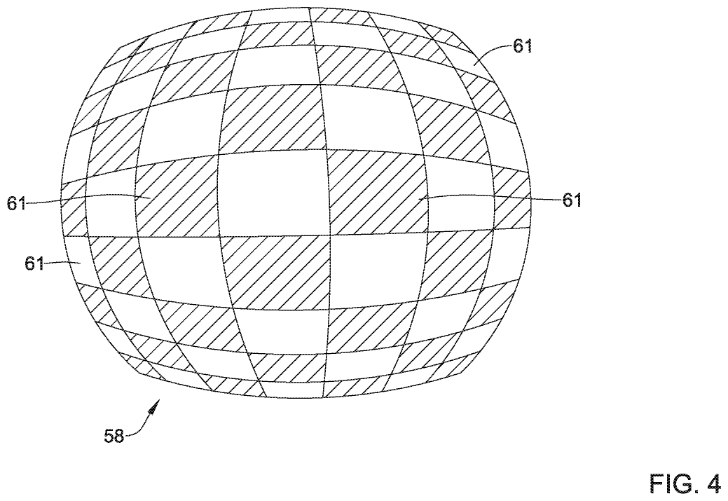

FIG. 5 is a schematic diagram of an illustrative substrate;

FIGS. 6A-6C are schematic view of an illustrative substrate;

FIGS. 7A and 7B are schematic views of an illustrative substrate;

FIGS. 8A and 8B are schematic views of an illustrative substrate;

FIGS. 9A and 9B are schematic views of an illustrative substrate;

FIG. 10 is a schematic diagram of an illustrative wide-angle imaging system;

FIG. 11 is a schematic diagram of an illustrative wide-angle imaging system;

FIG. 12 is a schematic diagram of an illustrative wide-angle imaging system;

FIG. 13 is a schematic chart of illustrative illumination from a plurality of illumination sources; and

FIG. 14 is a schematic box diagram of an illustrative method of using an analysis system.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DETAILED DESCRIPTION

For the following defined terms, these definitions shall be applied, unless a different definition is given in the claims or elsewhere in this specification.

The term “fluid” is inclusive of both liquids and gases.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “a configuration”, “some configurations”, “other configurations”, etc., indicate that the configuration described may include one or more particular features, structures, and/or characteristics. However, such recitations do not necessarily mean that all embodiments include the particular features, structures, and/or characteristics. Additionally, when particular features, structures, and/or characteristics are described in connection with one configuration, it should be understood that such features, structures, and/or characteristics may also be used in connection with other configurations whether or not explicitly described unless clearly stated to the contrary.

The following detailed description should be read with reference to the drawings in which similar structures in different drawings are numbered the same. The drawings, which are not necessarily to scale, depict illustrative embodiments and are not intended to limit the scope of the disclosure. Additionally, it should be noted that in any given figure, some features may not be shown, or may be shown schematically, for clarity and/or simplicity. Additional details regarding some components and/or method steps may be illustrated in other figures in greater detail. The devices and/or methods disclosed herein may provide a number of desirable features and benefits as described in more detail below.

Fluids with concentrations of volatile compounds (e.g., volatile organic compounds (VOCs)) and/or gasses, which may or may not be hazardous, may be sensed, analyzed, and/or monitored. Sensing, analyzing, and/or monitoring of fluids with analytes (e.g., non-volatile or volatile compounds, gases, liquids, and/or other fluids) may utilize images, light absorption, and/or light reflectance measurements of reactants exposed to such fluids for any purpose including, but not limited to, diagnostic hazard warning, manufacturing processes or quality control, record keeping, archival purposes, product development, product-consumer matching, etc.

In some cases, VOCs and/or gasses may be present in ambient fluid (e.g., ambient air, etc.) and sensed, analyzed, and/or monitored using reactants for real-time alarms, to treat subjects, or to collect and/or archive data for health records, regulatory compliance records, etc. Further, VOCs and/or gasses exhaled or emitted, excreted, emanated, released, and/or secreted from a subject (e.g., humans, animals other than humans, food, produce, meat, pathogens, bacteria (e.g., good and/or bad bacteria), plants, wounds, ulcers, surgical sites, skin of a subject, mouth of a subject, nasal passages of a subject, sinuses of a subject, rectum area of a subject, vaginal area of a subject, genitals area of a subject, ear canals of a subject, pores of a subject, etc.) may be sensed, analyzed, and/or monitored to assess hazardous, dangerous, or illegal substances in or at the subject or target site, a lung condition of lungs of a subject, a condition of a blood disease, a condition of infections, conditions related to diseases or biological conditions, metabolic state, conditions related to general health, conditions related to a response to treatment or therapy, conditions related to food flavors, conditions related to perfumes or smells, and/or other suitable conditions.

The systems discussed herein for sensing, analyzing, and/or monitoring fluids (e.g., for analytes of interest) may be configured to accurately detect and record a reactant array (e.g., a reactant array of or forming a colorimetric sensor array (CSA) or other suitable reactant array) response to exposure to the fluids. The systems may utilize techniques for non-invasively detecting one or more analytes of interest (e.g., one or more pathogens responsible for specific human skin infections including, but not limited to, skin infections, urinary tract infections (UTIs), vaginitis, wound infections, ulcers, etc., and/or other suitable analytes) from a fluid using a CSA to allow for early detection of and early implementation of protocols to address one or more conditions associated with any sensed analytes of interest. For example, the systems may be configured to non-invasively detect one or more analytes of interest (e.g., pathogens, metabolites, etc.) responsible for conditions (e.g., specific human skin infections, urinary tract infections (UTIs), vaginitis, wound infections, ulcers, health, age, response to a treatment or therapy, etc.) of a subject. In one example, enhanced classification of one or more analytes using the systems described herein may enable detection and identification of responsible pathogens at the very beginning stages of a dangerous skin infection, which may result in a high level of protection and probability of a favorable outcome for subjects.

An analysis system (e.g., a CSA analysis system) may include a substrate containing or otherwise supporting a reactant array and a device for reading or otherwise analyzing the reactant array before, during, and/or after the reactant array is exposed to a fluid. The device for analyzing the reactant array (e.g., a reader device) may be or may include any suitable image or light collector/sensor. In some instances, the device may be configured to be handheld. Further, the device for analyzing the reactant array may be configured to be simple to use, minimize human error, reduce cross contamination of samples, and reduce human risk of exposure to analytes received at the device. In some examples, a wide-angle imaging device or system may be utilized to analyze the reactant array. In some examples, wide-angle imaging devices or systems may facilitate imaging reactant arrays independent of whether the reactant array extends over a two-dimensional (2D) surface or extends over a three-dimensional (3D) surface. That is an analysis system utilizing a wide-angle imaging device or system may be configured to analyze reactant arrays on a 2D surface and reactant arrays on a 3D surface.

In operation, the substrate containing a reactant array may be placed at a desired location relative to the device for analyzing the reactant array (e.g., into, onto, etc. the device) during and/or through pre and post exposure to fluid for optimal reactant array analysis. That is, analysis of the reactant array may include analyzing the reactant array prior to exposure to the fluid, during exposure to the fluid, and/or after exposure to the fluid is complete. Once the analysis of the reactant array is complete or at last the imaging of the reactant array or capturing light from the reactant array is complete, the substrate with the reactant array thereon may be removed from the device for analyzing the reactant array and discarded. Having the substrate be disposable may prevent cross-contaminations of the reactant array and erroneous analyses (e.g., due to the previous fluids persisting in the tubing and reflowing over the reactant array, undesirably flowing onto a human, etc.).

The substrate may be any suitable component including one or more reactant arrays and that may be configured to expose the one or more reactant arrays to fluids from a target area or site. In one example, the substrate may be a monolithic component having the reactant array thereon. In one example, the substrate may be or may be part of a flow cell and may have an input port for receiving fluid (e.g., a fluid from a target area or site) to pass over and/or through the one or more reactant arrays and an output port for outputting the fluid passed through and/or over the one or more reactant arrays. In one example, the substrate may be configured to receive a specimen including a sample from a target area or site. Example suitable substrates or flow cells include, but are not limited to, those described in, PCT Application No. PCT/US23/83076, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

Two-dimensional (2D) objects (e.g., flat objects, planar objects, flat or planar surfaces, etc.) and three-dimensional (3D) objects (e.g., non-flat objects, non-planar objects, non-flat or non-planar surfaces, etc.) may be imaged using one or more light or image sensors (e.g., imaging sensors). Colorimetric Sensor Arrays (CSAs) for sensing a presence of an analyte may include a 2D array of reactants on a planar surface (e.g., square surface, a rectangular surface, a circular surface, etc.) When imaging the CSA with the reactant array on the planar surface, the imaging systems (e.g., cameras, etc.) may relay the object onto a planar image sensor (a charge-coupled device (CCD) image sensor, complementary metal-oxide semiconductor (CMOS) image sensor, fixed imaging system, etc.) If, however, the reactant array is 3D or on a 3D or non-planar surface, conventional imaging systems that only focus at one distance (e.g., a focal plane) may be out of focus and/or blurred for any portion or detail of the reactant array that is not at that one distance (e.g., is closer or farther way from an image sensor of the imaging system than the focal plane), which may result in a loss of detail and/or information in the image sensed by the image sensor.

A non-planar surface profile (e.g., concave surface profile, etc.) of a substrate for placement of a reactant array may be configured to be used with one or more wide-angle lenses (e.g., fisheye lens, etc.) to create well-in-focus images of the reactants of the reactant array that may be optically relayed/imaged onto a flat image sensor such that all of the reactants may have or may essentially have the same optical magnification or demagnification (e.g., the reactants are not distorted or any distortion is mitigated). In some examples, the non-planar surface profile of the substrate may be optimized or otherwise configured for use with existing wide-angle lens imaging systems. The benefits of such a configuration of the analysis system include, but are not limited to, allowing for a compact optical design of a reader device with substantially low, if any, optical distortion, allowing for use of different cost-levels of wide-angle lenses, and allowing for different cost-levels of image sensors/cameras.

Further, the disclosure may include designs of illumination systems with illumination sources being positioned, angled/aimed, and beam-shaped to produce optimized light intensity distribution on the non-planar surface of the substrate at which the reactant array is located and/or through the substrate to the reactant array. The illumination sources may be configured to provide light to a front side of the substrate (e.g., a side on which the reactant array is located) and/or to a back side of the substrate such that the light passes through the substrate to the reactant array on or at the front side of the substrate (e.g., a transmissive approach). In some example configurations of the illumination system, a polarization of the illumination and/or imaging beams from the illumination sources may be optically manipulated. Such designs or configurations of illumination systems may facilitate uniform illumination of the reactants of the reactant array, while also suppressing or mitigating specular reflections or deflections of illumination reflected from a surface of the substrate, reflected from a surface (e.g., a surface of a transparent layer) overlaid on top of a 3D surface at which the reactant array is located, or passed through the substrate, so only diffusely reflected or scattered or reemitted light from the reactants will be received and captured by the imaging sensor. Reducing or mitigating specular reflections or deflections may improve the signal to noise ratios of the overall imaging or spectrum measurement system.

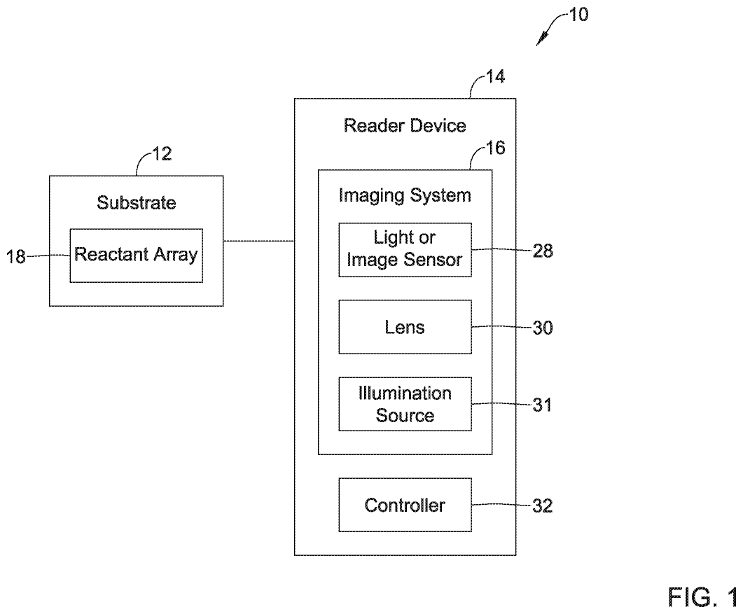

Turning to the Figures, FIG. 1 depicts a schematic diagram of an illustrative system 10 for analyzing a reactant array. Among other components the system 10 may include a substrate 12 having the reactant array 18 and a reader device 14 configured to monitor and/or analyze the reactant array 18.

The substrate 12 may have any suitable configuration and may include any suitable components configured to facilitate the reactant array 18 interacting with a fluid of interest. Example components of the substrate 12 include, but are not limited to, one or more reactant arrays 18, a support structure, a planar surface supporting the reactant array(s) 18, a non-planar surface supporting the reactant array(s) 18, a baffle, a standoff, one or more compartments, one or more locks, one or more specimen detectors, a housing, a window for viewing the reactant array 18, a blade, gasket, one or more access openings extending between the compartments and exterior of the housing, one or more valves configured to seal the access opening, one or more doors or lids, one or more pumps for pumping fluid of interest to the reactant array 18, one or more fluid paths or passages, one or more optical paths, tubing, one or more diaphragms or membranes, one or more single-use components or code, and/or other suitable components.

The substrate 12 may be formed from any suitable material. Example suitable materials for the substrate 12 include, but are not limited to, polymers, metals, glass, natural fibers, a transparent material, an opaque material, and/or other suitable types of materials.

The substrate 12 may have any suitable shape and/or size configured to support the reactant array 18 or facilitate exposing the reactant array 18 to a fluid of interest. For example, the substrate 12 may have a cube shape, an elongate shape, a rectangular shape, an oval shape, a rounded shape, a circular shape, semi-circular shape, a cup shape, a ball shape, and/or other suitable shape.

In some cases, the substrate 12 may be reusable. For example, in instances when the reactant array 18 and/or other components of the substrate 12 that may be spent or contaminated with a received fluid, the reactant array 18 and/or other spent or contaminated components of the substrate 12 may be removed from the substrate 12 and the remaining components of the substrate 12 may be reused after cleaning, as needed. In some cases, the reactant array 18 may include reversible reactant material and the reactant array 18 may be reused with other components of the substrate 12.

The reactant array 18 may be any suitable array of one or more reactants (e.g., analyte sensitive material) and the reactants of the reactant array 18 may be formed from any suitable material. In some examples, the reactant array 18 may be configured to be supported by or housed within the substrate 12. In some cases, the reactant array 18 may be part of or may form a colorimetric sensor array (CSA), but other suitable configurations are contemplated. When the reactant array 18 forms or is otherwise part of a CSA, the substrate 12 may or may not be part of the CSA. Additionally or alternatively, the reactant array 18 may be formed by applying the material of the reactants to a planar or non-planar surface of the substrate 12.

The reactant array may be a composite of one or more reactants, where each reactant may have a base color (e.g., an unexposed color) that may be configured to change in color (e.g., a transmitted wavelength may change) and/or in intensity (e.g., an amount of reflection) when the reactants are exposed to an analyte (e.g., non-volatile and/or volatile compounds, gases, liquids, and/or other fluids). The material of the reactants of the reactant array 18 may be reversible (e.g., reusable), semi-reversible, or non-reversible (e.g., single use). In some examples, the material of the reactants may be an optically responsive chemical material (e.g., a chemoresponsive material) that changes color in response to detecting one or more analytes (e.g., volatile compounds gasses, liquids, and/or other fluids) in a fluid to which the reactants are exposed, but other suitable material is contemplated. Example suitable materials for reactants include dyes from, but not limited to, the following classes: Lewis acid/base dyes (e.g., metal containing dyes), Brensted acidic or basic dyes (e.g., pH indicators), dyes with large permanent dipoles (e.g., solvatochromic dyes), redox responsive dyes (e.g., metal nanoparticle precursors), and/or other suitable classes of dyes. One example material for the reactants may be a silver nanoparticle material. Other suitable materials for the reactants are contemplated, including reactant material other than a printed dye or an optically responsive chemical material.

The reactants of the reactant array 18 may be applied to the substrate 12 in any suitable manner. In one example, the reactants may be applied to the substrate 12 by printing the reactants (e.g., the material of the reactants) on the substrate 12. When printed, any suitable printing techniques may be utilized including, but not limited to, pin transfer, inkjet, silkscreen, and/or other suitable application techniques.

The reactants of the reactant array 18 may be applied to the substrate 12 randomly and/or to form one or more patterns. Example configurations of the reactants of the reactant array 18 applied to the substrate 12 include, but are not limited to, continuous patterns, partition patterns, segmented patterns, perforated patterns, dots, strips, grid patterns of rows and columns, concentric rings, color matching of a color of printed dye material with a color of a substrate material prior to interactions of the reactants with analyte, patterns that result in identifiable shapes when the analyte sensitive material reacts to a particular analyte, other suitable configurations, and/or combinations thereof.

In addition to or as part of the reactant array 18, the substrate 12 may include physical and/or optical registration features that may be used by the reader device 14 to align and/or register the substrate 12 and/or the reactant array 18 with the reader device 14 for analysis prior to, during, and/or after exposing the reactant array 18 to a fluid of interest. In some examples, a registration feature on or of the substrate 12 may facilitate comparison analyses of images of the reactant array 18.

The reader device 14 may include one more suitable components for reading and/or analyzing the reactant array 18. Example suitable components of the reader device 14 include, but are not limited to, an imaging system 16, light collection components, one or more light or image sensors 28 (e.g., imaging sensors), one or more windows, one or more sets of lenses 30, one or more light components or illumination sources 31 configured to illuminate the reactant array 18, one or more substrate detectors, one or more controllers 32, one or more motors, one or more pumps, one or more buttons, one or more user interfaces, one or more displays, and/or other suitable components. In some examples, the reader device 14 may be a bench top device or a handheld device. In some cases, the reader device 14 may be isolated from an area of the substrate 12 that is exposed to a fluid of interest and may be configured for reuse.

Although not required, a pump or a pump component may be integrated into the reader device 14 to draw fluids into, over, and/or through the reactant array 18. Furthermore, the pump or a pump component may entirely or at least partially reside in the substrate (as discussed) and actuation of the pump may be initiated at the reader device 14 and/or at one or more other suitable locations. In some examples, the pump or pump components may connect to the substrate 12 via one or more ports on a proximal end (inside the reader device 14) and the distal end of the substrate 12 may have one or more port(s) for connecting tubes that may be in fluid communication with a source of fluids. The pump and/or the reader device 14 may include external ports that a user may connect to tubing that fluidly couples with a port of the substrate 12, the fluid source, and/or other suitable components. Additionally or alternatively, the reader device 14 and/or the substrate 12 may include one or more components configured to receive a tubing, where a pump or pump component (e.g., a peristaltic pump or pump component and/or other suitable pumps) may interact with the received tubing to draw fluids into, over, and/or through the reactant array.

The reader device 14 may be powered with any suitable power source. Example suitable power sources for powering the reader device 14 include, but are not limited to, battery power in the reader device 14, solar power at the reader device 14, wall or line power, and/or other suitable power sources. In some examples, to facilitate forming the reader device 14 with a handheld configuration, the reader device 14 may be powered by one or more batteries and/or by solar power.

The light or image sensor 28 of the imaging system 16 may be, may include, or may be included in one or more light collectors of any suitable type. Example suitable types of light collectors may include, but are not limited to, a light sensor, an imaging sensor, an n-dimensional sensor array (e.g., where “n” equals 1, 2, etc.), a one-dimensional sensor array, a linear two-dimensional (2D) light detector array image sensor, a 1-chip image sensor, light detector array image sensor, a photodiode array, a spectrometer, a refractometer, CCD image sensor, CMOS image sensor, a fixed imaging sensor, contact image sensor (CIS), color contact image sensor (CCIS), a monochrome image sensor, a 1-chip monochrome image sensor, a 1-chip color image sensor, a camera, a digital single-lens reflex (DSLR) camera, other suitable light collectors, and/or combinations of light collectors. In one example, the light collector may include or may be a spectrometer configured to measure photons collected from (e.g., reflected, transmitted, and/or otherwise received from) the reactant array. Utilizing a spectrometer may facilitate sensing wavelengths of light with high resolution in the nanometer range and may provide a continuous set of data over the wavelength range, which allows for a sensitive analysis of the data to identify components of a fluid to which the reactant array 18 was exposed relative to when other light collectors are used. In another example, the light collector may include a 2D pixel array image sensor configured to record multiple spatial interferograms in a pixel array direction of an interferogram representing a Fourier transform of the reactant array 18, which may provide sufficient sensitivity, while being compact and cost-effective. In another example, the light collector may include a fixed imaging sensor to provide a facilitate compact form of the reader device 14. In another example, the light collector may include or be included in a DSLR camera.

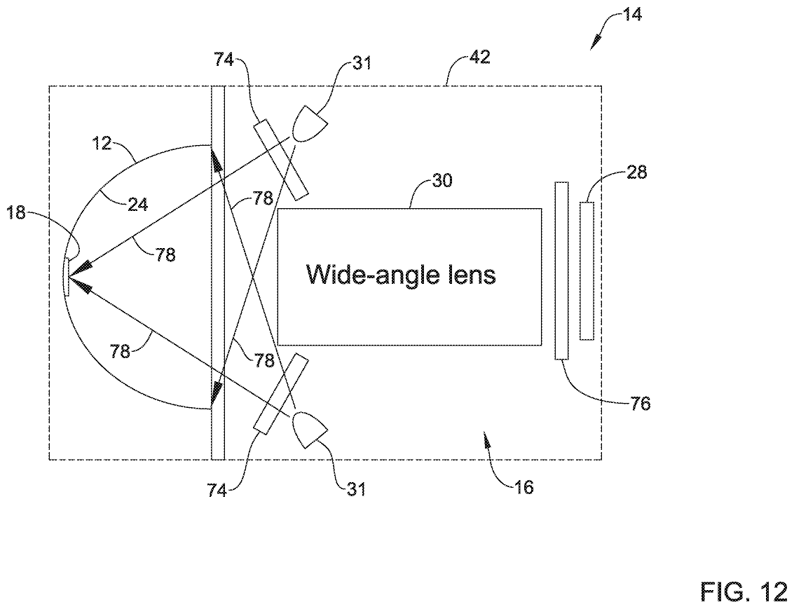

Further, any suitable 2D light or image sensor 28 in either board level or mounted/housed/packaged format may be utilized. In some examples, the 2D light or image sensor 28 may be part of a compact camera module design. Example suitable compact camera module designs include, but are not limited to, 2MP AR0230 WDR USB Camera Module Manual Focus M12 Lens for Raspberry Pi, Windows, Linux, Mac OS, and Android, MCY-6080(4K/2160P 30PFS USB 2.0 CMOS Camera Module w/SONY IMX415) (FIG. 12), Waveshare OV5693 5MP USB Camera, Fixed-focus, Auto Focusing, M12 Camera Module, and/or other suitable compact camera modules.

The lenses of the one or more sets of lenses 30 of the imaging system 16 may have any suitable individual configuration and/or configurations with respect to one or more other lens, when included. Example suitable configurations of the lenses 30 include, but are not limited to, a rod lens array, a gradient or graded refractive index rod lens array, SELFOC lens array (SLA), a wide-angle lens, a fish-eye lens, and/or other suitable type or configuration of lens. In one example configuration, the lens 30 may include one or more wide-angle lenses.

The reader device 14 may include or be used with a one or more lenses 30 configured as a wide-angle lens. Typically, normal lenses have a focal length in a range of 50 millimeters (mm) to 70 nm and a field of view of in a range of 46 degrees to 34 degrees. A lens having a focal length greater than 70 mm and a field of view of less than 34 degrees may be a telephoto lens. A lens having a focal length of 49 mm or less and a field of view of 47 degrees or greater may be a wide-angle lens. Within the wide-angle lens classification, a standard wide-angle lens may have a focal length in a range of 25 mm to 35 mm and a field of view of in a range of 85 degrees to 45 degrees and an extreme wide-angle lens may have a focal length in a range of 0 mm to 24 mm and a field of view of in a range of 180 degrees to 84 degrees. A fish-eye lens may be a considered an extreme wide-angle lens and may have focal length of less than 14 mm and a field of greater than 114 degrees. In one example, the one or more lenses 30 configured as a wide-angle lens may have a field of view between 60 degrees and 200 degrees, but other suitable field of views for a wide-angle lens are contemplated.

Any suitable wide-angle lenses 30 may be used in the imaging system 16 of the reader device 14. For example, suitable wide-angle lenses may include, but are not limited to, lenses with a focal length of 35 mm or shorter, extreme wide-angle lenses (e.g., lenses with a focal length of 24 mm or shorter), rectilinear lenses, fisheye lenses, prime wide-angle lenses, ultra-wide-angle lenses, full frame fisheye lenses, circular fisheye lenses, and/or other suitable wide-angle lenses. In one example, the lens 30 having a wide-angle configuration may be a fisheye lens.

Any suitable lens mount may be used with the one or more lenses 30. Example suitable lens mounts include, but are not limited to, an M12 lens or S mount, C mounts, CS mounts, custom mounts, and/or other suitable mounts.

The one or more illumination sources 31 may utilize any suitable type(s) of illuminate sources and may have any suitable configuration. Example suitable types of illumination sources 31 include, but are not limited to, light emitting diodes (LEDs), broad spectrum (visible range, for example) LEDs, discrete wavelength LEDs (400 nm, 600 nm, 700 nm, for example), illumination sources that would create fluorescence or phosphorescence, and/or other suitable illumination sources. The illumination sources 31 may be configured within the imaging system 16 to project light onto, through, or otherwise illuminate a target area at substrate 12 using one or more of optical lenses, fiber optics, light pipes, encapsulated LEDs structures alone, micro-structured optical components, and/or other suitable optical components, which may or may not be part of the illumination sources 31.

Any suitable combination of one or more illumination sources 31 may be utilized to illuminate a target. The illumination sources 31 may be interior of a housing of the reader device 14 or exterior of the housing. In some examples, one, two, or more than two illumination sources 31 may be utilized to illuminate a target area (e.g., the focal plane of the light or image sensor 28, an object plane at which an object to be imaged is located, etc.) from a viewing side of the target and/or a back side of the target (e.g., through a transparent substrate on which the target is located and/or in one or more other suitable manners). Although other illumination source configurations are contemplated, example suitable illumination source (e.g., light source) configurations are described in PCT Application No. PCT/US23/83024, entitled DEVICES, METHODS, AND SYSTEMS FOR MEASURING AND RECORDING A REACTANT ARRAY, filed on Dec. 8, 2023, which is hereby incorporated by reference in its entirety for any and all purposes and PCT Application No. PCT/US23/83063, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

The light from the illumination sources 31 may be configured to substantially minimize specular reflection of the light from any surface (e.g., such as a flat surface like a glass slide cover that may rest on top of the object or surface to be imaged). For example, specular reflection of illumination light may be mitigated by not only arranging the illumination sources 31 to have specular reflections directed mostly away from entering an imaging or optical path, but also with the use of polarization properties and means to cross out specular reflections, or with diffusion at the illumination source 31 or between the illumination source 31 and the surface at which the object is to be imaged.

When utilizing a plurality of LEDs or other suitable discretely activated light sources as part of the illumination sources 31, the LEDs or other light sources may be configured to be turned on and off individually or collectively. Selectively turning on one or more LEDs or selectively turning off one or more LEDs (e.g., turning on an individual LED and turning all others off) may allow for choosing specific wavelengths of illumination of the reactants of the reactant array 18 that are ideally suited for sensing specific analytes that may be present in a fluid to which the reactant array 18 is exposed and may facilitate reducing optical noise (crosstalk) while maximizing a reflected/absorbed signal of a wavelength of most interest. When the substrate 12 includes the reactant array 18 that is exposed to a fluid of interest and is to be imaged for analysis, selectively turning on and/or off one or more of the LEDs or other suitable illumination sources 31 may reduce optical noise from adjacent reactants of the reactant array 18 while maximizing a wavelength signal of most-interest that is associated with a reactant in the reactant array 18 configured to be sensitive to an analyte of interest in the fluid to which the reactant array 18 was exposed, thus maximizing a signal-to-noise ratio of the light or image sensor 28. Such a process of turning on and/or off one or more of the LEDs or other suitable illumination sources 31 may also improve a wavelength signal from a weaker or less-sensitive reactant of the reactant array 18.

In some examples, the light from the illumination source 31 may be under full control of the imaging system 16 or a user operating the imaging system 16, which may facilitate the complete removal of ambient background light interference. The complete removal of ambient background light interference may allow for the use of a monochrome image sensor in combination with multiple illumination sources 31 of different spectral ranges or colors, so in addition to the use of a standard Bayer pattern based RGB color image sensor to get three spectrums and/or other suitable color image sensors, hyperspectral imaging of the object or surface (e.g., of the reactant array 18) may be realized by sequentially lighting up different spectral range light sources. Additionally, the background ambient light captured by the sensor and with illumination turned off with the reactant array in position may be partially or fully subtracted as part of the analysis to further reduce ambient contributions (e.g., improve signal to noise of image).

Combining a monochrome or black-and-white light or image sensor 28 with different spectral range light sources 31 (e.g., LEDs of different colors), may result in achieving a higher quantum efficiency or light sensitivity of a monochrome light or image sensor 28 in comparison to that of a 1-chip color light or image sensor 28. Further, the color cross talk from the monochrome or black-and-white light or image sensor 28 used with different spectral range light resources may be less than cross talk from the red, green, and blue channels of a typical Bayer pattern filter array based 1-chip color light or image sensor 28.

The use of a 1-chip monochrome light or image sensor 28 may allow for more spectral channels with narrower spectral bandwidth at a lower cost and a much smaller form factor than other hyperspectral cameras. When individual illumination sources 31 are individually controllable, each spectral range light source 31 (e.g., each LED chip/die) can be lit or turned on sequentially in synchronization with the frame rate of the monochrome image sensor 31 (e.g., a frame rate of the imaging system 16 utilizing a global shutter) to realize not only three spectral channel RGB imaging, but also multiple spectral channel hyperspectral imaging. Further, when light sources 31 (e.g., LEDs) of different spectral range or peak wavelengths are used (e.g., to further reduce spectral channel cross talk), different optical bandpass filters may be positioned in front of different corresponding illumination sources 31 to remove the spectral tails of the original illumination source 31 emission spectrum and thus, to substantially further reduce spectral cross talk between light from different reactants of the reactant array 18, resulting in a desired quality of hyperspectral imaging.

Although not depicted in FIG. 1, the reader device 14 may include one or more substrate detectors (e.g., a reactant array detector) and/or single-use components. In some examples, the substrate detector may be configured to detect when the substrate 12 is proximate and/or received in the reader device 14. The single-use component of the reader device 14 may include a feature configured to electrically, mechanically, or electrically and mechanically modify the substrate 12 such that the substrate 12 will not be used more than once by the reader device 14 (e.g., in more than one test by the reader device 14). Other suitable substrate detectors and/or single-use components are contemplated.

The controller 32 of the reader device 14 may be configured to control operations of the reader device 14 in response to receiving one or more control signals and/or use inputs. The controller 32 may store captured data at the reader device 14 and/or send data to a remote storage component for storage and the controller 32 may use stored captured data to analyze the reactant array 18. Further, the controller 32 may be implemented entirely on the reader device 14, partially on the reader device 14 and partially remotely, or entirely remotely (e.g., on a server or other suitable computing device, on the substrate 12, on a user's mobile device, etc.)

The controller 32 of the reader device 14 may be coupled to one or more other electronic components of the system 10. For example, the controller 32 may be communicatively coupled with the light or image sensor 28, one or more of the illumination sources 31, the cartridge detector, the single-use component, and/or one or more other suitable components of the system 10 and/or remote components (e.g., servers, mobile devices, etc.) that may or may not be part of the system 10. In some examples, the controller 32 may be configured to receive an indication to initiate a fluid test (e.g., from a user via a user interface of or in communication with the controller 32, from the cartridge detector, etc.) and send coordinated control signals to one or more electronic components of the system 10.

The controller 32 may be configured to identify or may facilitate identifying a component of fluid in contact with the reactant array 18 and/or a condition of a target area based on measured (e.g., sensed and/or calculated) levels of light (e.g., interferograms, images, reflectance, etc.) or changes in light sensed or collected from the reactant array 18 with the light or image sensor 28. In some examples, the controller 32 may be configured to identify a component of fluid in contact with the reactant array 18 and/or a condition at or of the target area based on one or more of a timing of levels of light from the reactant array 18, an absolute change between a light from or an image of the reactant array 18 at a time of or prior to exposure to a fluid of interest and at a predetermined time of or after initially exposing the reactant array to the fluid of interest, and light from or an image of the reactant array 18 relative to predetermined or expected light from or a previous image of the reactant array 18. Example suitable techniques for analyzing light collected from or an image of the reactant array include, but are not limited to, those described in PCT Application No. PCT/US23/83024, entitled DEVICES, METHODS, AND SYSTEMS FOR MEASURING AND RECORDING A REACTANT ARRAY, filed on Dec. 8, 2023, which has been incorporated by reference herein. The controller 32 may be configured to identify the component of the fluid in contact with the reactant array 18 and/or a condition at a location from which the fluid of interest was taken (e.g., a wound, pollen from a flower, an infection, an exhalation from a subject, a sweat gland, etc.) based on light from the reactant array 18 that is received at the light or image sensor 28 in one or more additional or alternative manners.

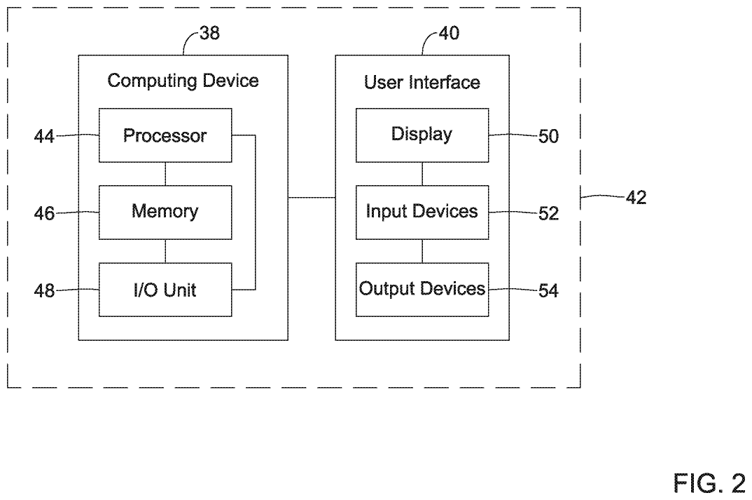

The controller 32 and/or other components of the system 10 may be or may include one or more computing devices including or coupled with one or more user interfaces. FIG. 2 depicts a schematic diagram of an illustrative computing device 38 and a user interface 40, where the computing device 38 and/or the user interface 40 may be entirely or partially housed in one or more housings 42 (e.g., a housing which may or may not house other components of the system 10). The housing 42 may be an optional component, as represented by the broken lines defining the housing 42 depicted in FIG. 2. Although various components are depicted as being included in the computing device 38 and the user interface 40, one more of the depicted components may be omitted and/or one or more additional or alternative components may be utilized.

The computing device 38 may be any suitable computing device configured to process data of or for the system 10 and may be configured to facilitate operation of the system 10. The computing device 38, in some cases, may be configured to control operation of the system 10 by establishing and/or outputting control signals to the light or image sensor 28 and/or other electronic components of the system 10 to run a test on fluid from a target area that interacts with the reactant array 18 and/or monitor results of a test. In some examples, the computing device 38 may be part of the controller 32 and may communicate with other components over a wired or wireless connection, but other suitable configurations are contemplated. When the computing device 38, or at least a part of the computing device 38, is a component separate from a structure of the controller 32, the computing device 38 may communicate with electronic components of the system 10 over one or more wired or wireless connections or networks (e.g., LANs and/or WANs). In some cases, the computing device 38 may communicate with a remote server or other suitable computing device.

The illustrative computing device 38 may include, among other suitable components, one or more processors 44, memory 46, and/or one or more input/output (I/O) units 48. Example other suitable components of the computing device 38 that are not specifically depicted in FIG. 2 may include, but are not limited to, communication components, a touch screen, selectable buttons, and/or other suitable components of a computing device. As discussed, one or more components of the computing device 38 may be separate from the controller 32 and/or incorporated into the components of the controller 32.

The processor 44 of the computing device 38 may include a single processor or more than one processor working individually or with one another. The processor 44 may be configured to receive and execute instructions, including instructions that may be loaded into the memory 46 and/or other suitable memory. Example components of the processor 44 may include, but are not limited to, central processing units, microprocessors, microcontrollers, multi-core processors, graphical processing units, digital signal processors, application specific integrated circuits (ASICs), artificial intelligence accelerators, field programmable gate arrays (FPGAs), discrete circuitry, and/or other suitable types of data processing devices.

The memory 46 of the computing device 38 may include a single memory component or more than one memory component each working individually or with one another. Example types of memory 46 may include random access memory (RAM), EEPROM, flash, suitable volatile storage devices, suitable non-volatile storage devices, persistent memory (e.g., read only memory (ROM), hard drive, flash memory, optical disc memory, and/or other suitable persistent memory) and/or other suitable types of memory. The memory 46 may be or may include a transitory or a non-transitory computer readable medium. The memory 46 may include instructions stored in a transitory state and/or a non-transitory state on a computer readable medium that may be executable by the processor 44 to cause the processor 44 to perform one or more of the methods and/or techniques described herein. Further, in some cases, the memory 46 and/or other suitable memory may store data received from the light or image sensor 28 and/or other components of or in communication with the system 10.

The I/O units 48 of the computing device 38 may include a single I/O component or more than one I/O component each working individually or with one another. Example I/O units 48 may be or may include any suitable types of control lines (e.g., discrete digital, logic, or analog), communication hardware, and/or software including, but not limited to, communication components or ports configured to communicate with electronic components of the system 10 and/or with other suitable computing devices or systems. Example types of I/O units 48 may include, but are not limited to, wired communication components (e.g., HDMI components, Ethernet components, VGA components, serial communication components, parallel communication components, component video ports, S-video components, composite audio/video components, DVI components, USB components, optical communication components, and/or other suitable wired communication components), wireless communication components (e.g., radio frequency (RF) components, Low-Energy BLUETOOTH protocol components, BLUETOOTH protocol components, Near-Field Communication (NFC) protocol components, WI-FI protocol components, optical communication components, ZIGBEE protocol components, and/or other suitable wireless communication components), and/or other suitable I/O units 48.

The user interface 40 may be configured to communicate with the computing device 38 via one or more wired or wireless connections. The user interface 40 may include, among other components, one or more display devices 50, one or more input devices 52, one or more output devices 54, and/or one or more other suitable features. Although not depicted, the user interface 40 may include one or more indicators (e.g., light emitting diodes (LEDs), LED linear arrays, numbers, etc.) In some examples, the user interface 40 may be part of or may include the computing device 38. Alternatively or additionally, the user interface 40 may be part of a mobile device or remote computing system.

The display 50 may be any suitable display. Example suitable displays include, but are not limited to, touch screen displays, non-touch screen displays, liquid crystal display (LCD) screens, LED displays, head mounted displays, virtual reality displays, augmented reality displays, a mobile device display, and/or other suitable display types. In some examples, the display 50 may be configured to depict an image captured by the reader device 14 (e.g., captured by the light or image sensor 28). The image may be a live image and/or a photograph or image captured at a previous time. In one example, the image may be a live image of the reactant array 18. Further, the display 50 may display material other than the image including, but not limited to, instructions for testing a fluid, a test status (e.g., a progression of steps in an analysis of the reactant array 18), a system status, results of an analysis of the reactant array 18, marketing indicia, brand indicia, videos, user pictures, art work, etc.

The input device(s) 52 may be and/or may include any suitable components and/or features for receiving user input via the user interface 40. Example input device(s) 52 may include, but are not limited to, touch screens, keypads, mice, touch pads, microphones, selectable buttons, selectable knobs, optical inputs, cameras, gesture sensors, eye trackers, voice recognition controls (e.g., microphones coupled to appropriate natural language processing components) and/or other suitable input devices. In one example, the input devices 52 may include a touch screen that allows for setting set points, initiating a fluid or target area analysis test, adjusting between screens (e.g., a testing screen, a data analysis screen, a results screen, user manual, etc.), and/or allows for taking one or more other suitable actions.

The output device(s) 54 may be and/or may include any suitable components and/or features for providing information and/or data to users and/or other computing components. Example output device(s) 54 include, but are not limited to, displays, speakers, vibration systems, tactile feedback systems, optical outputs, and/or other suitable output devices.

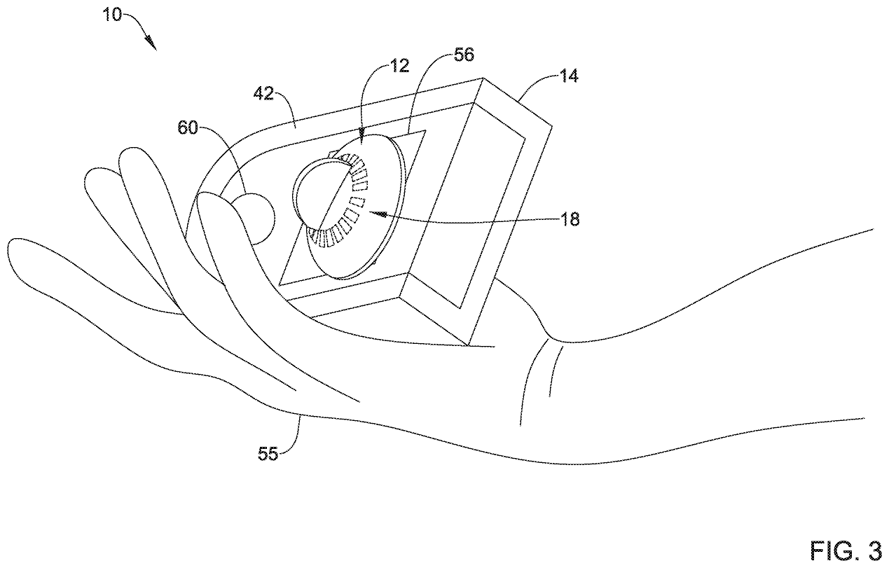

FIG. 3 schematically depicts an illustrative configuration of the system 10 configured to be held in a hand 55 of a user. Although the system 10 may take on a variety of different handheld configurations (and/or non-handheld configurations), the system 10 depicted in FIG. 3 may include the substrate 12 positioned at the reader device 14 for imaging and/or analysis of the reactant array 18 thereon. The reactant array 18 may be on a side of the substrate 12 facing a window 56 of the reader device 14 through which the light from or an image of the reactant array 18 may be captured. In some examples, the reader device 14 may include a holder (not shown) as part of or separate from the housing 42 and may be configured to position the reactant array 18 at a desired location against the window 56 and/or spaced from the window 56 (e.g., distal of an outer surface of the window 56) to facilitate imaging the reactant array 18 with the light or image sensor 28 (not shown in FIG. 3) proximal of the window 56 and within the housing 42. When the substrate 12 and the reactant array 18 are spaced distal of the window 56, the space between the window 56 and the substrate 12 may facilitate utilizing an optical relay between the reactant array 18 and the window 56, facilitate receiving a specimen with a sample to be tested (e.g., a sample providing a fluid of interest) between the substrate 12 and the window 56, and/or the space between the window 56 and the substrate 12 may facilitate receiving other suitable components.

Although it may desirable to minimize blurring or cross-talk between different reactants of the reactant array 18, some blurring of the individual reactants in an image of the reactants array 18 may facilitate analysis of the reactant array 18 by naturally averaging the color data of individual reactants of the reactant array 18 (e.g., the color data from the reactant array 18 before, during, and/or after exposure of the reactant array 18 to a fluid). Averaging color data of an individual reactant of the reactant array 18 may facilitate accounting for different exposures of the reactant to the fluid being analyzed and/or interactions between the reactant and the fluid being analyzed.

The 3D surface or non-planar surface of the reactant array 18 to be imaged and/or 3D surface or non-planar surface of the substrate 12 on which the reactant array 18 that is to be imaged is located may have any suitable 3D or non-planar configuration. For example, the imaging system 16 having one or more lenses 31 configured as wide-angle lenses may be used for imaging concave surfaces or reactant arrays 18 or other suitable objects on concave surfaces including, but not limited to, a concave spherical surface, a hemispherical surface, a parabolic surface, a hyperbolic surface, an ellipsoidal surface, a stepped surface, a stepped concave surface, a surface with concave shapes that have rotational symmetry, and/or any other suitable surfaces with concave shapes.

In some examples and as discussed, an imaging system (e.g., a compact imaging system or other suitable imaging system) including a wide-angle imaging lens in combination with a flat image sensor may be used to image non-planar objects and/or surfaces, where the wide-angle lens may be configured to optically relay non-planar objects and/or surfaces to the flat image sensor. Such a configuration may facilitate imaging 3D objects (e.g., non-planar objects) and surfaces using an imaging system with a small or compact form factor (e.g., with a short object distance from the lens, which may be about 25 mm or less) that results in little or no optical distortion (e.g., where the field curvature may be flat on the flat image sensor resulting in an in-focus image of the object with little, if any, optical distortion).

The imaging system may utilize uniform illumination of the object or surface (e.g., non-planar object or surface) to be imaged. For example, the light sources of the imaging system may be arranged at certain positions with certain pointing angles, properly engineered light emitting angular and/or spatial intensity distributions, and/or certain intensity profile overlapping schemes to achieve uniform illumination of the non-planar object or surface to be imaged.

As discussed, imaging system utilizing a wide-angle lens 30 and uniform illumination of the reactant array 18 or other object to be imaged, may solve the problem of a lack of focus and/or large optical distortion in captured images of a relatively large object optically imaged to a flat image sensor over a short distance (e.g., a short distance between the object or surface and one or more lenses between the image sensor and the object or surface). For example, by positioning the reactant array 18 on a 3D surface (e.g., concave surface) and using an imaging system 16 with a wide-angle lens (e.g., a fisheye imaging lens) and a flat or 2D light or image sensor 28, the image of the reactant array 18 that is formed on the light or image sensor 28 may be in focus across a large field of view with minimum optical distortion and meanwhile the form factor of the overall imaging system may be compact or very small.

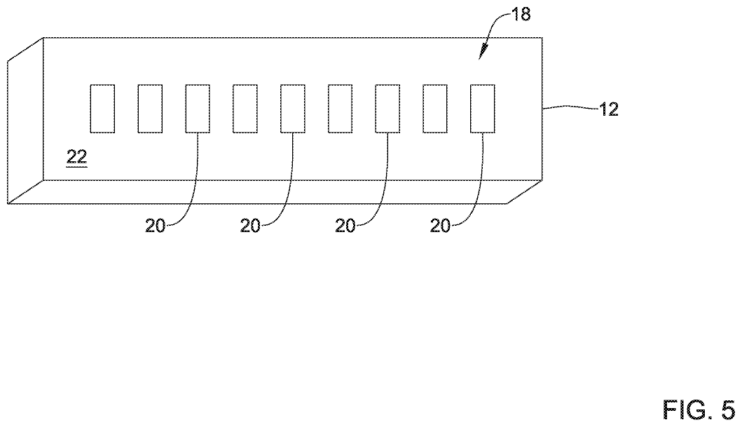

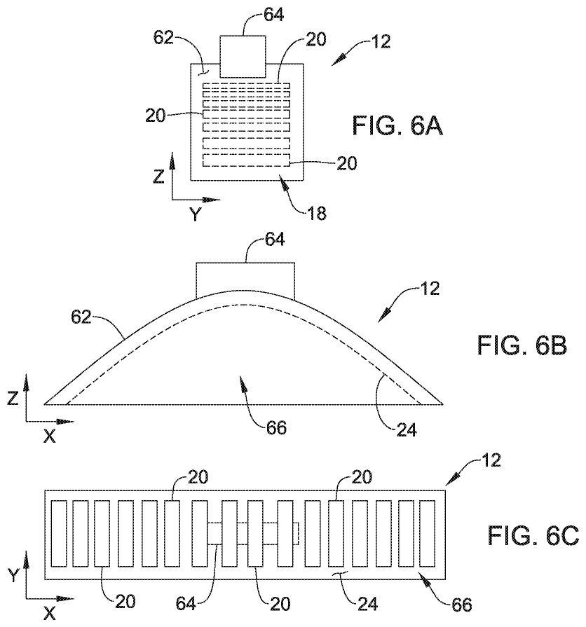

As discussed, the reactant array 18 may have or may be located on a planar, 2D surface or on a non-planar, 3D surface. FIGS. 5-9B depict schematic diagrams of illustrative configurations of the substrates 12 having reactants 20 (not all reactants 20 are labeled for clarity purposes) of the reactant arrays 18 on various configurations of surfaces. Though FIGS. 6A-9B depict rotationally symmetrical and rotationally non-symmetrical concaves surface with reactants 20 thereon, other 3D, non-planar surface geometries are considered. Although not depicted in FIGS. 5-9B, the substrate 12 may include a single-use component, registration component, or code for reading by the reader device 14 as part of or separate from the reactant array 18. Further, although all of the reactants 20 in FIGS. 5-9B are depicted as having a rectangular shape, other suitable shape of the reactants 20 are contemplated, as discussed herein or otherwise. Further, the substrates 12 depicted in FIGS. 5-9B may be opaque, transparent, or in-between completely opaque and completely transparent. Additionally or alternatively, the substrates 12 depicted in FIGS. 5-9B may be non-porous or porous or gas-permeable.

FIG. 5 is a schematic diagram of an illustrative substrate 12 with the reactant array 18 thereon. As depicted in FIG. 5, the substrate 12 may be configured as a 3D rectangle having a planar or 2D surface 22 on which the reactants 20 of the reactant array 18 are located. Although the substrate 12 has a 3D rectangular shape, the substrate may have one or more other suitable shapes with the planar or 2D surface 22.

FIGS. 6A-6C depict schematic views of an illustrative configuration of the substrate 12 having a 3D or non-planar concave surface on which the reactants 20 of the reactant array 18. In some examples, the substrate 12 having a 3D, non-planar surface may be rotationally asymmetric (e.g., may be rectangular, square, oval, etc.) In some examples, the substrate 12 may include a handle 64 for grasping by a user or tool and configured to facilitate a user holding the substrate 12 to position the substrate 12 over an area of interest or otherwise grasp or pick-up the substrate 12.

FIG. 6A schematically depicts a side view of the substrate 12 from a Z-axis by Y-axis plane showing an exterior surface 62 of the substrate 12, where the reactants 20 of the reactant array 18 are shown in broken lines to demonstrate the reactant array 18 is on an interior surface of the substrate 12. Further, the reactants 20 of the reactant array 18 decrease in height along the Z-axis to demonstrate the reactants 20 in FIG. 6A-6C are on a concave, non-planar or 3D surface.

FIG. 6B schematically depicts a side view of the substrate 12 from a Z-axis by X-axis plane. A concave, 3D or non-planar surface 24 on which the reactant array 18 is located is depicted in FIG. 6B in broken lines to demonstrate the concave, 3D or non-planar surface may be an interior surface of the substrate 12. In some examples, the 3D or non-planar surface 24 may define a compartment or space 66 exposed to the reactant array 18 and configured to receive fluid to be analyzed.

FIG. 6C schematically depicts a bottom view of the substrate 12 from a Y-axis by X-axis plane showing the exterior surface 62 of the substrate 12. As depicted in FIG. 6C, the reactants 20 of the reactant array 18 may be located on the concave, non-planar or 3D surface 24 that may entirely or at least partially define compartment or space 66. Although the reactant array 18 extends a full length of the non-planar or 3D surface 24 and the reactants 20 of the reactant array are uniformly sized, other suitable configurations of the reactant array 18 are contemplated.

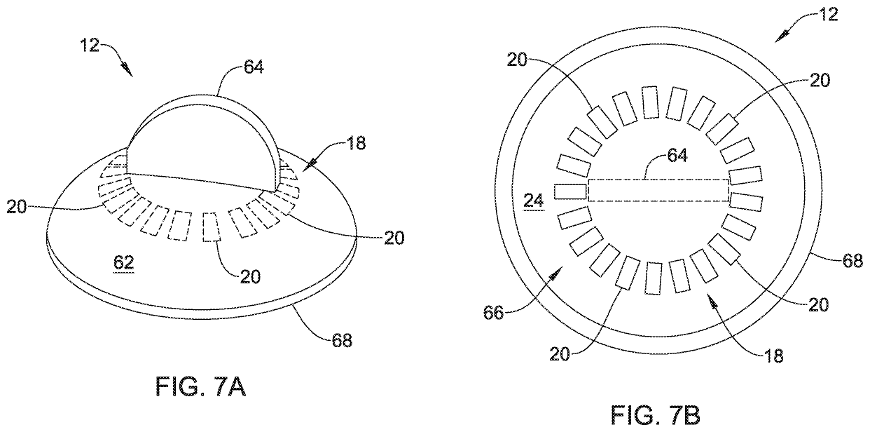

FIG. 7A schematically depicts a perspective view of an illustrative configuration of the substrate 12 with the handle 64, showing the exterior surface 62 of the substrate 12 having a domed shape with an outer edge 68. The reactants 20 of the reactant array 18 are depicted in broken lines as the reactants 20 of the reactant array 18 are on the interior concave, 3D, non-planar surface 24 of the substrate 12.

FIG. 7B schematically depicts a bottom view of the substrate 12, where the reactant array 18 may be configured as an annular array of the reactants 20 on the interior concave, 3D, non-planar surface 24 of the dome-shaped substrate 12. As depicted in FIGS. 7A and 7B the reactant array 18 and the 3D non-planar surface 24 may be rotationally symmetric. Other suitable configurations of the reactants 20 are contemplated.

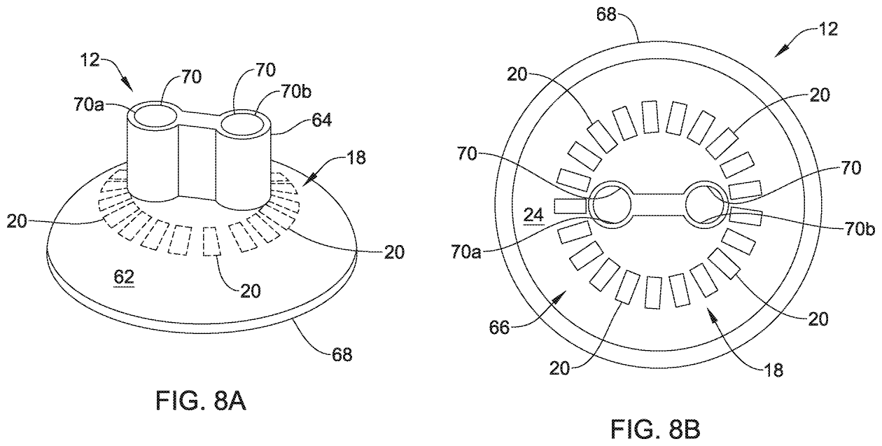

FIG. 8A schematically depicts a perspective view of an illustrative configuration of the substrate 12 with the handle 64, showing the exterior surface 62 of the substrate 12 having a domed shape with an outer edge 68. The reactants 20 of the reactant array 18 are depicted in broken lines as the reactants 20 of the reactant array 18 are on the interior concave, 3D, non-planar surface 24 the substrate 12.

The substrate 12 may include one or more ports 70 in fluid communication with an underside of the substrate 12 at which the reactant array 18 is located (e.g., see FIG. 8B) and facilitates moving or passing fluid into and/or out of the concave side of the substrate 12. The one or more ports 70 may be configured to receive a fluid input and/or a fluid output. In some examples, tubing may be coupled to the ports 70 to facilitate passing or moving agitation fluid and/or fluid that may include analytes into or out of a volume defined by the concave, 3D, non-planar interior surface 24. In some examples, the one or more ports 70 may be configured to receive an adaptor having a fluid input pathway and a fluid output pathway. Alternatively or additionally and as depicted in FIGS. 8A and 8B, a first port 70a of the one or more ports 70 may be configured to couple with a fluid input pathway and a second port 70b of the one or more ports 70 may be configured to couple with a fluid output pathway. In some examples, at least one of the one or more ports 70 may be part of the handle 64 and/or at least one of the one or more ports 70 may be separate from the handle 64. Other suitable configurations of the ports 70 are contemplated.

FIG. 8B schematically depicts a bottom view of the substrate 12, where the reactant array 18 may be configured as an annular array of the reactants 20 on the interior concave, 3D, non-planar surface 24 of the dome-shaped substrate 12 defining the compartment or space 66. In some examples, the reactant array 18 may extend around the one or more ports 70 extending through the interior concave, 3D, non-planar surface 24. Other suitable configurations of the reactants 20 are contemplated. Although not depicted in FIG. 8B, one or more valves may be positioned at the one or more ports 70 to facilitate controlling fluid flow through the one or more ports 70 (e.g., in response to pressure changes relative to the valve, in response to a control signal, etc.)

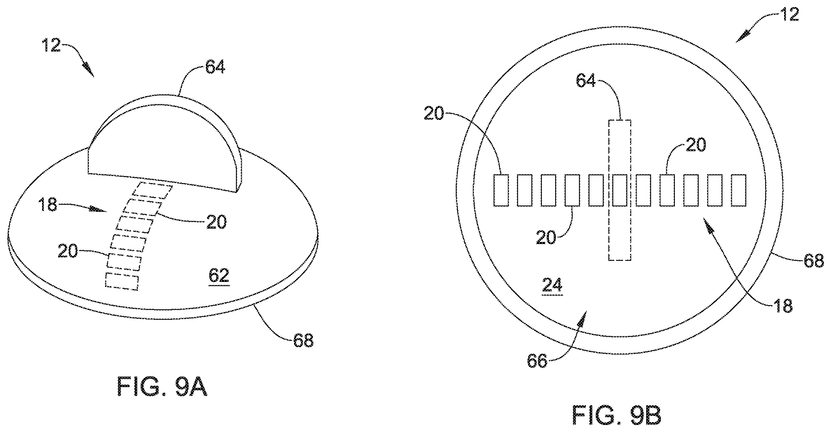

FIG. 9A schematically depicts a perspective view of an illustrative configuration of the substrate 12 with the handle 64, showing the exterior surface 62 of the substrate 12 having a domed shape with an outer edge 68. The reactants 20 of the reactant array 18 are depicted in broken lines as the reactants 20 of the reactant array 18 are on the interior concave, 3D, non-planar surface 24 of the substrate 12.

FIG. 9B schematically depicts a bottom view of the substrate 12, where the reactant array 18 may be configured linearly with the reactants 20 extending in a single row on the interior concave, 3D, non-planar surface 24 of the dome-shaped substrate 12 defining the compartment or space 66. Other suitable configurations of the reactants 20 are contemplated.

The substrate 12 with the 3D or non-planar surface 24 and having the reactant arrays 18 thereon may be configured to facilitate positioning the substrate 12 and the reactant array 18 onto, over, on top of, and/or otherwise about an area of interest where detection of analytes is sought. In a clinical application and/or an in-the-field application, for example, areas of interest may include, but are not limited to, an infected site on the patient's skin, surgical site, respiratory, vaginal, wound, burn, a urine sample, and/or other suitable locations and the 3D or non-planar surface may be configured to extend over and be supported by adjacent surfaces without engaging the area of interest. In one example, the substrate 12 configured to facilitate positioning the substrate 12 and the reactant array 18 about an area of interest may be a dome-shaped substrate (e.g., a substrate with a concave surface) similar to as depicted in FIGS. 7A-9B, but other suitable configurations are contemplated.

In some examples, the substrates 12 with the reactant array 18 on the 3D, non-planar surface 24 may be used in the following workflow: 1) take an image of the reactant array 18 prior to use, 2) place the reactant array 18 over a target area or area of interest (e.g., over a skin infection, etc.), 3) leave the reactant array 18 in place at the target area or area of interest and supported by a surface around the target area or area of interest for some period of time for fluid from the target area or area of interest to interact with the reactant array 18, 4) remove the reactant array 18 from the target area or area of interest with or without sealing the volume or space defined by the concave, 3D, non-planar surface of or on which the reactant array 18 is located, and 5) reimage the reactant array 18 to determine changes in color or spectrum of the reactants 20, if any, which may indicate a presence of one or more target analytes of interest. Other suitable workflows including additional or alternative features or steps are contemplated.

The substrate 12 with the reactant array 18 located on or having a concave surface or other suitable 3D, non-planar surface may include one or more advantages over substrates with a reactant array 18 located on a 2D, planar surface. In one example, the reactants 20 on the concave surface or other suitable 3D, non-planar surface may not be at risk or are at less of a risk of coming into contact with the infected site than reactant arrays 18 on a 2D, planar surface, which mitigates a risk of the reactants 20 being in contact with fluids, puss, skins, blood, or other elements in, on, or around a target site, as unintended contact with fluids, puss, skin, blood, and/or other elements around the target site may make the dye of the reactant 20 ineffective and could contaminate the patient with the chemicals of the reactant 20. In another example, the concave surface or other suitable 3D, non-planar surface may create a volume (e.g., a large volume, as in the compartment or space 66) for the analytes to fill relative to when the reactants 20 are on a 2D, planar surface, which may increase a concentration of the analytes in a manner that increases a number of molecules interacting with the reactants 20. Increasing the number of molecules that interact with the reactants 20 may facilitate analyzing a fluid for analytes because the molecules that interact with the reactants 20 are effectively consumed and no longer available, thus with more molecules there are more interaction opportunities. In another example, the concave surface or other suitable 3D, non-planar surface of the substrate 12 may increase a total surface area of space for the reactant 20, which may allow for the reactant 20 to be placed over a larger area for maximizing the molecular interactions and facilitates using more combinations of reactants than is possible when the reactants 20 are placed only on a 2D, planar surface of the substrate 12. In another example, when ports (e.g., the ports 70 depicted in FIGS. 8A and 8B and/or other suitable ports) are available, fluids (gasses) may be passed to a space enclosed by or under the concave surface to stimulate the analyte from the target area or target site to produce more molecules and/or to help distribute the molecules about the reactants 20 on the concave surface or other suitable 3D, non-planar surface. In another example, when the substrate 12 includes ports 70 for passing fluid to a space proximate the concave surface or other suitable 3D, non-planar surface, the substrate 12 may be a standalone component and be standing alone from (e.g., not be placed onto/over) an area of interest, but still be positioned to allow analytes to be directed (flowed) into a volume defined by the concave surface for detection by the reactants on the concave surface. When the substrate 12 has a standalone configuration, a portion of the substrate 12 that is usually placed onto/against an area of interest could be covered with a transparent material (e.g., sealing the hemisphere) to contain the fluids/gasses within the hemisphere but allow for imaging of the reactants.

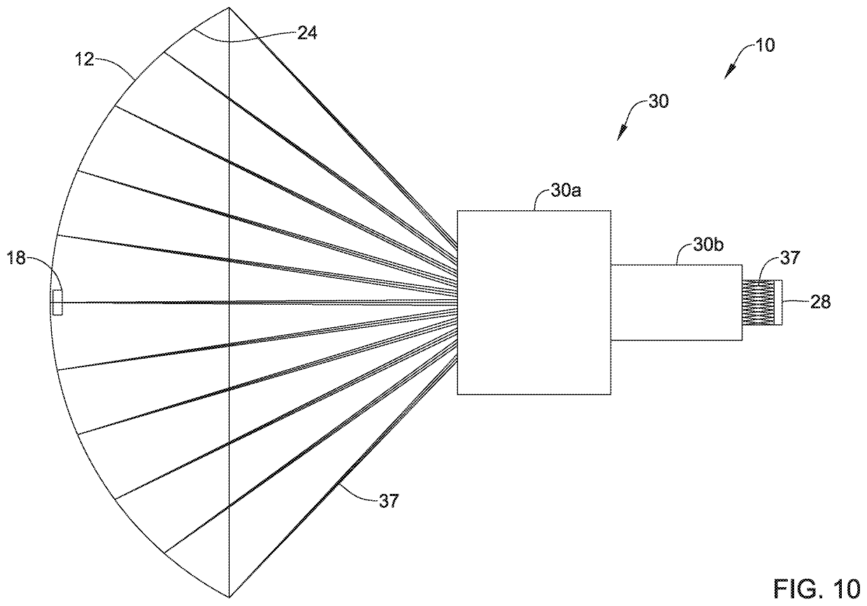

FIG. 10 schematically depicts an illustrative configuration of the system 10, with the imaging system 16 having a wide-angle lens configuration designed to image the substrate 12. The substrate 12 may have the 3D, non-planar surface 24 on which the reactant array 18 may be located. The components of the imaging system 16 may be part of a camera or may be separate components aligned to capture an image of or light from the reactant array 18 on the substrate 12.

As depicted in FIG. 10, the imaging system 16 may include one or more lenses 30 with a wide-angle lens configuration and the light or image sensor 28. The one or more lenses 30 may be located between the light or image sensor 28 and the substrate 12. In one example, the one or more lenses 30 may include a first lens 30a and a second lens 30b configured to work together to form a wide-angle lens configuration. Light rays 37 may extend from the reactant array 18 and/or the concave, 3D, non-planar surface 24 travelling through the wide angle lens 30 to focus on the light or image sensor 28. The fact that the light rays 37 emitted from one or more points (of a number of substantially equally spaced points) on the concave, 3D, non-planar surface 24 are focused to a substantially small spot on the image sensor 28 (of a number of substantially equally spaced image spots) indicates there is minimum optical distortion or blurring. Other suitable configurations of the one or more lenses 30 are contemplated. In one example, the imaging system 16 may be configured to have a depth or length of 15 mm or less between the light or image sensor 28 and a side of the lens 30 farthest from the light or image sensor 28, but other suitable depths or lengths of the imaging system 16 are contemplated. In one example configuration of the imaging system 16, the lens 30 may be a 120-degree fish-eye M12 lens and the light or image sensor 28 may be a 6.35 mm CMOS 2D image sensor, which may be suitable for imaging a concave surface having a diameter of about 40 mm and/or other suitably sized concave surfaces. Other suitable configurations of the imaging system 16 with a wide-angle lens configuration are contemplated.

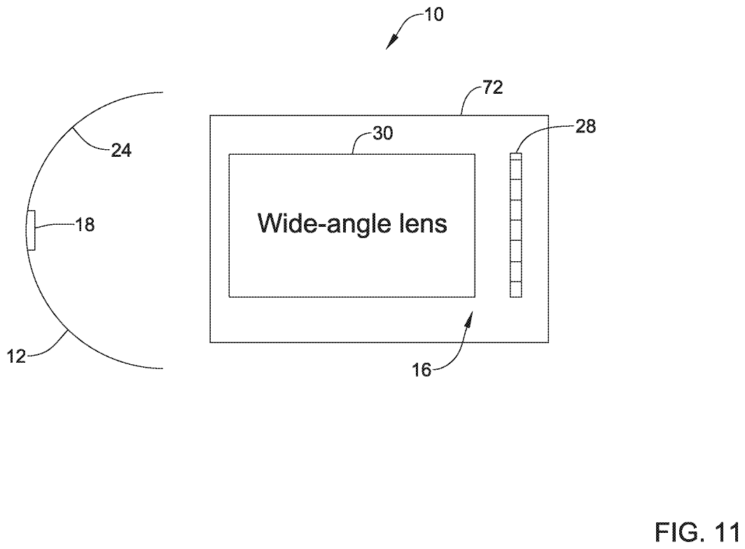

FIG. 11 schematically depicts an illustrative configuration of the system 10 with the substrate 12 having a concave or other suitable 3D, non-planar surface 24, the reactant array 18 thereon, and the imaging system 16 as part of or otherwise configured as a camera 72. In some examples, the camera 72 may have a compact configuration (e.g., a camera configured to fit within or be part of a handheld reader device 14) and include the imaging system 16 with the one or more lenses 30 having a wide-angle configuration and the light or image sensor 28. In one example configuration, the one or more lenses 30 of the imaging system 16 may be configured as a fish-eye lens with a total length of 13 mm and a focal length of 2 mm and the light or image sensor 28 may be a CMOS 1-chip color or monochrome imaging sensor with a sensor size of ⅓ inch, which in combination may facilitate forming the compact configuration of the camera 72. In one example, the camera 72 having a compact design may have a length or depth of 15 mm or less, but other suitable lengths or depths are contemplated for cameras 72 forming a compact design. In one example, the overall depth or length of the system 10 from the light or image sensor 28 to a center and apex of the concave surface 24 may be configured to be about 50 mm, where the length or depth may be configured to obtain a best-focused image at the center of the concave surface or other suitable 3D, non-planar surface 24 of the substrate 12 while mitigating a size of the camera 72, but other suitable depths or lengths of the system 10 are contemplated.

The imaging system 16 may be configured to image a configuration of the substrate 12 with particular concave or other suitable 3D, non-planar surfaces to ensure an image captured by the light or image sensor 28 of the imaging system 16 is in focus and optical distortion is mitigated. A focus, blur, or distortion of images captured with the imaging system may be minimized by adjusting a radius of curvature of the concave surface or other suitable 3D, non-planar surface 24 and/or adjusting a lens configuration of the imaging system 16.

As discussed, illumination paths may be designed with one or more features to achieve relatively uniform illumination on the 3D, non-planar surface of the substrate 12, which may substantially minimize specular reflections of illumination light and facilitate red, green, and blue spectral channel imaging, along with hyperspectral imaging. FIG. 12 schematically depicts an illustrative configuration of the system 10, with an illumination path 78 extending from the illumination sources 31 to the substrate 12 with the reactant array 18 thereon. In some examples, the illumination sources 31 may be configured as an annular ring of light sources 31 (e.g., an annular ring of LEDs and/or other suitable light sources) around the one or more lenses 30. When the light sources 31 include an annular array of LEDs around the wide-angle lens 30 or the light or image sensor 28, one or more of the LEDs may comprise a single color or multiple semiconductor LED chips/dies that emit light of one or more colors of different spectral bands.

The illumination sources 31 may utilize opposing pairs of LEDs in some examples. By utilizing opposing LED pairs (e.g., FIG. 12 schematically depicts an opposing pair of LEDs) an intensity distribution on the concave surface or other suitable 3D, non-polar surface 24 may be uniform or substantially uniform with desired beam divergence angles.

When utilizing LEDs as part of the illumination source(s) 31, the LEDs may be individually selectable and configured to be turned on or off individually or collectively. Selectively turning on one or more LED and selectively turning one or more LED off (e.g., turning on an individual LED and turning all others off) may facilitate reducing optical noise (crosstalk) while maximizing a reflected/absorbed reactant (e.g., formulation/chemical/etc.) signal of a wavelength of light of most interest or sensitivity and improving a signal of a weaker responding formulation. Selectively turning on and/or off particular LEDs may allow for choosing specific wavelengths of illumination of the reactants of the reactant array 18 that are ideally suited for specific analytes in the fluid.

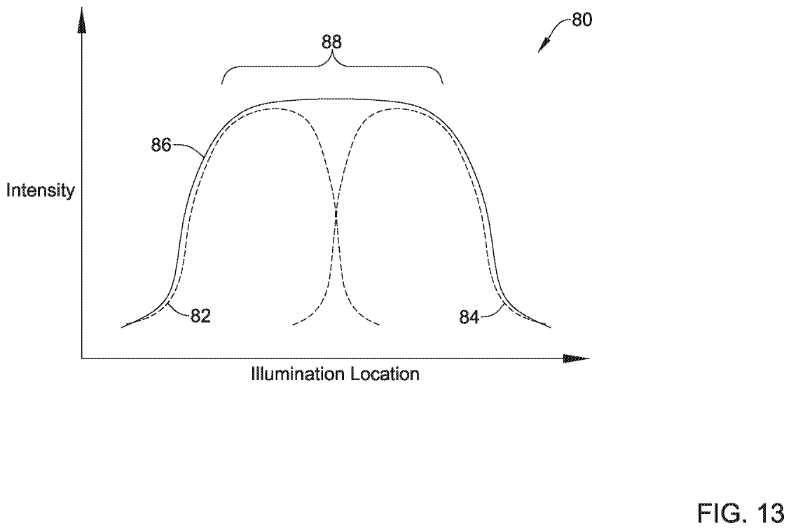

FIG. 13 depicts a chart 80 of angular intensity distribution of illumination on the concave or other 3D, non-planar surface 24 of the substrate 12 from individual illumination sources 31 utilizing opposing pairs of LEDs, as depicted for example in FIG. 12. A first curve 82 in the chart 80 may be representative of an angular intensity distribution of one illumination source 31 of the pair of LEDs and a second curve 84 in the chart 80 may be representation of an angular intensity distribution of the other illumination source 31 of the pair of LEDs. The typically bell-shaped angular intensity distribution of the first curve 82 and the second curve 84 may overlap to form a combined curve 86 in the chart 80. The combined curve 86 is representative of the angular intensity distribution of the combined illumination from the pair of LEDs. The central region 88 of the combined curve 86 shows the combined illumination from the LED pair provides a more flattened intensity distribution where the illumination from the illumination sources overlap and across the full field of view.

An angular intensity distribution of the light sources 31 may be selected or modified or the illumination beam may be reshaped by using a standard or customized diffused lens/dome or by adding a standard or customized diffuser/lens in front of the LED. When a diffuser is utilized, the diffuser may be custom made with microstructures so different light rays from the LED can be redirected to different directions to realize a desired angular intensity distribution. The pointing direction of each LED may be either on the meridian plane or in a skewed direction. In other words, the center line of the divergent light beam from each LED can be either on the meridian plane containing an optical axis of the wide angle lens or at a skewed angle relative to the optical axis of the wide-angle lens to further direct specular reflection away from returning to the imaging path.

Returning to FIG. 12, an illumination polarizer 74 (e.g., an annular ring polarizer and/or other suitable illumination polarizer) may be arranged in front of the illumination source 31 between the illumination source 31 and the reactant array 18 to polarize the light provided along a light or illumination path 78 to the reactant array 18. Further, an imaging polarizer 76 may be arranged in front of the light or image sensor 28 (as shown) or in front of the wide-angle lens (not shown) along an image path to cross out any specular reflection of the light from the substrate 12 or an optical window covering a concave volume at least partially defined by the substrate 12. The illumination polarizers 74 and/or the image path polarizers 76 can cover the full spectral range of interest (such as the full visible light range) and may be linear or circular or elliptical polarizers or other suitable polarizers as long as the illumination path polarizers 74 and the image path polarizers 76 are orthogonal or perpendicular in the sense that specular reflection can be substantially crossed out. Individual illumination polarizers 74 may be arranged in front of each LED as long as the polarization direction of all the illumination beams is maintained substantially the same. In some examples, the illumination polarizers 74 and/or the image path polarizers 76 may be thin film linear polarizers, such as, for example, the AP42-004T from American Polarizer and/or other suitable polarizers.

When the illumination sources 31 include an LED array and one or more LEDs from the LED array may be able to emit different multiple colors or spectral bands, diffused or clear lensed LEDs may be arranged with each LED pointing to the opposing side of the concave surface or other 3D, non-planar surface 24 of the substrate 12. Each color spectral band of the illumination sources 31 may be individually addressed or driven or turned on and the light or image sensor 28 (e.g., a 1-chip image monochrome or black/white image sensor) can be used in combination with synchronized sequential lighting up of each color or spectral band when an electronic shutter (not shown) of the imaging system 16 is opened. In some examples, the imaging system 16 may be enclosed in a light tight black housing 42 so ambient background light is completely blocked and prevented from landing on the light or image sensor 28. In this way, not only red, green, and blue (such as those produced by a Tri-Color LED) but also hyperspectral imaging of the reactants on the concave surface can be easily realized.

When different single spectral LEDs are used as or as part of the illumination sources 31, quadrant-paired opposing LEDs of the same color or spectral band (i.e. four LEDs of the same spectral band, oriented 90 degree from one another) may be arranged around an annular ring behind the illumination polarizer 74. In such a configuration, every 4 quadrant-paired opposing LEDs may enable substantially uniform illumination over the full field of view of the concave surface or other suitable 3D, non-planar surface 24 of the substrate 12. By rotationally sequentially lighting up or turning the 4 quadrant-paired opposing LEDs, multiple spectral or hyperspectral images of the reactant array 18 may be obtained. The number of spectral bands may be increased by increasing the number of different spectrally separated LEDs using either smaller size or dome-lens diameter LEDs or even having not only just one LED ring but more than one LED rings (for example, 2 rings, 3 rings, 4 rings, or more rings).

In an example configuration of the imaging system 16, white LEDs may be utilized as or as part of the illumination sources 31 and the light or image sensor 28 may be a 1-chip color image sensor such that spectral separation of the red, green, and blue channel information can be directly obtained from the light or image sensor 28. Additionally or alternatively, a filter (e.g., a tunable band pass spectral filter or tunable notch filter) may be used in combination with the light or image sensor 28 (e.g., a monochrome 1-chip image sensor) such that the tuning of the tunable spectral filter may be synchronized with the opening of light or image sensor 28. In such a case, the filter may be arranged in front of the light or image sensor 28 and the illumination source 31 (e.g., a white light source) may have a light emission spectrum that covers the full visible spectrum or even extending into near infrared range (e.g., such as the Optisolis™ high color rendering white LED, and the Olympus TrueColor LED).

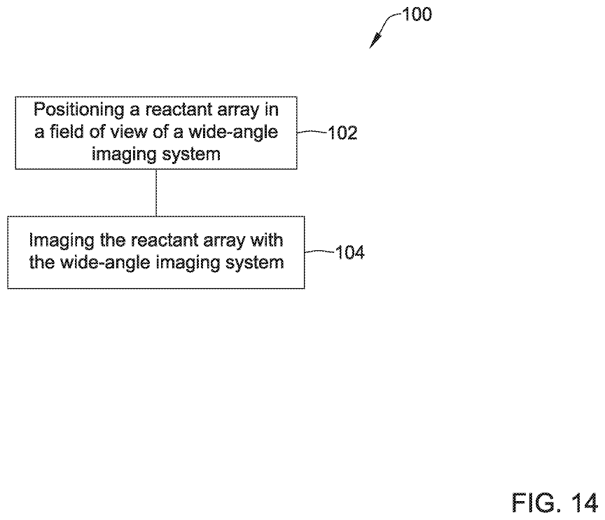

FIG. 14 schematically depicts a box diagram of an illustrative method 100 of using an analysis system. The method 100 of using the analysis system may include reading or analyzing a reactant array on a substrate with a reader device having an imaging system. The imaging system may have a wide-angle lens or field of view and a 2D or flat image sensor. In some examples, the 2D or flat image sensor may be a monochrome image sensor or a multi-color image sensor configured to create a hyperspectral image of the reactant array. Other suitable configurations of the imaging system are contemplated.

The reactant array may be on a 2D or 3D surface of the substrate. In one example, the reactant array may be on 3D, non-planar surface of the substrate.

The method 100 may include positioning 102 a reactant array in the wide-angle field of view of the imaging system of the reader device. Prior to or while the reactant array is in the field of view of the imaging system, the reactant array may be exposed to one or more fluids. In some examples, the reactants of the reactant array may be configured to react to one or more analytes of interest when the one or more analytes of interest are present in the one or more fluids.

The method 100 may further include imaging 104 the reactant array in the field of view of the imaging system by collecting light from (e.g., an image of) the reactant array with the wide-angle imaging system. The light may be collected from the reactant array before, during, or after exposing the reactant array to the fluid. In one example, light may be collected from or an image may be taken of the reactant array prior to exposure to the fluid and then again after exposure to the fluid. In some examples, a wide-angle lens of the wide-angle imaging system may have a field of view configured to match a concave surface of the substrate on which the reactant array is located to facilitate obtaining in-focus and non-distorted light from or images of the reactant array.

The light from and/or images of the reactant array may be analyzed to determine which analytes of interest were present in the fluid that was exposed to the reactant array. In some examples, analyzing the light from and/or images of the reactant array may include comparing two or more of the following: an image obtained from imaging the reactant array before exposing the reactant array to the one or more fluids, an image obtained from imaging the reactant array while exposing the reactant array to the one or more fluids, and an image obtained from imaging the reactant array after exposing the reactant array to the one or more fluids. In some examples, the light from or images of the reactant array from before exposure to the fluid may be compared to the light from or images of the reactant array after exposure to the fluid for analyzing whether an analyte of interest was present in the fluid exposed to the reactant array. In some examples, a reactant of the reactant array may indicate an analyte associated with the reactant was present in fluid when the comparison indicates there was a change in color or shape of the reactant in response to exposure to the fluid.

In some examples, the reactants of the reactant array may be illuminated with light from the imaging system. Illumination of the reactants of the reactant array may be used to improve the spectral response of the reactants to a fluid, as captured by the imaging system. Any suitable illumination of the reactants of the reactant array are contemplated including, but not limited to, those illumination techniques discussed herein.

The components of the analysis system 10 discussed herein (e.g., the substrate 12, the reactant array 18, the reader device 14, the lenses 30, the light or image sensor 28, the illumination sources, etc.) and/or other suitable components may be separate components and/or two or more of the of the components of the system 10 may be integrated into a single component. The components of the system 10 discussed herein may be made and/or formed in any suitable manner. For example, one or more of the components of the system 10 discussed herein may be formed using molds, injection molding techniques, 3D printing techniques, machining techniques, and/or other suitable techniques. The components of the system 10 discussed herein may be formed from any suitable materials including, but not limited to, glass, plastics, metals, transparent mediums with the appropriate optical properties, silicon, and/or other suitable materials.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Unless otherwise expressly stated, it is in no way intended that any method or technique set forth herein is to be construed as requiring that its steps be performed in a specific order. This holds for any possible non-express basis for interpretation, including matters of logic with respect to arrangement of steps or operational flow, plain meaning derived from grammatical organization or punctuation, and the number or type of embodiments described in the specification.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

The follow references may describe examples of one or more features discussed herein: PCT Application No. PCT/US23/83068, entitled DEVICES, METHODS, AND SYSTEMS FOR MEASURING AND RECORDING A REACTANT ARRAY, filed on Dec. 8, 2023, which is hereby incorporated by reference in its entirety for any and all purposes; PCT Application No. PCT/US23/83073, entitled DEVICES, METHODS, AND SYSTEMS FOR MEASURING AND RECORDING A REACTANT ARRAY, filed on Dec. 8, 2023, which is hereby incorporated by reference in its entirety for any and all purposes; PCT Application No. PCT/US23/83104, entitled DEVICES, METHODS, AND SYSTEMS FOR MEASURING AND RECORDING A REACTANT ARRAY, filed on Dec. 8, 2023, which is hereby incorporated by reference in its entirety for any and all purposes.

What is claimed is:

1. A system comprising:
a substrate comprising a reactant array; and
a wide-angle imaging system having a wide-angle field of view,
wherein the wide-angle imaging system is configured to capture an image of the reactant array along an optical path through the wide-angle field of view.

2. The system of claim 1, wherein the wide-angle imaging system comprises a flat imaging sensor.

3. The system of claim 1, wherein the wide-angle imaging system comprises a monochrome imaging sensor.

4. The system of claim 1, wherein the wide-angle imaging system comprises a color imaging sensor.

5. The system of claim 1, further comprising:
an illumination source configured to illuminate the reactant array.

6. The system of claim 1, wherein the substrate has a non-planar surface and the reactant array is on the non-planar surface.

7. The system of claim 1, wherein the substrate has a planar surface and the reactant array is on the planar surface.

8. The system of claim 1, wherein the wide-angle imaging system comprises a controller configured to process the image captured by the wide-angle imaging system.

9. A device comprising:
a wide-angle lens;
a flat imaging sensor;
an illumination source; and
a housing configured to house the wide-angle lens, the flat imaging sensor, and the illumination source,
wherein the illumination source is configured to illuminate an object and the flat imaging sensor is configured to capture light from the object through the wide-angle lens.

10. The device of claim 9, wherein the illumination source comprises an annular array of a plurality of individually selectable light sources positioned around the flat imaging sensor.

11. The device of claim 9, wherein the flat imaging sensor is configured to capture the light from the object to form a hyperspectral image of the object.

12. The device of claim 9, wherein the flat imaging sensor is a monochrome imaging sensor.

13. The device of claim 9, wherein the flat imaging sensor is a color imaging sensor.

14. The device of claim 9, further comprising:
a controller positioned within the housing, the controller is configured to process an image from the light captured by the flat imaging sensor.

15. A method comprising:
positioning a reactant array in a wide-angle field of view of a wide-angle imaging system; and
imaging the reactant array by collecting light from the reactant array with the wide-angle imaging system.

16. The method of claim 15, further comprising:
illuminating the reactant array with light from the wide-angle imaging system.

17. The method of claim 15, further comprising:
exposing the reactant array to one or more fluids, wherein the reactant array is configured to react to one or more analytes of interest when the one or more analytes of interest are present in the one or more fluids.

18. The method of claim 15, wherein collecting light from the reactant array with the wide-angle imaging system comprises collecting light from the reactant array with a flat imaging sensor of the wide-angle imaging system.

19. The method of claim 15, wherein collecting light from the reactant array with the wide-angle imaging system comprises collecting light from the reactant array with a monochrome imaging sensor of the wide-angle imaging system.

20. The method of claim 15, wherein collecting light from the reactant array with the wide-angle imaging system comprises collecting light from the reactant array with an imaging sensor of the wide-angle imaging system to create a hyperspectral image of the reactant array.
